(19) United States
(12) Patent Application Publication
(10) Pub. No.: US 2026/0025018 A1
(43) Pub. Date: Jan. 22, 2026

(54) BATTERY AND LOAD CONTROL SYSTEMS AND METHODS

(71) Applicant: Briggs & Stratton, LLC, Wauwatosa, WI (US)

(72) Inventors: Jacob Schmalz, Milwaukee, WI (US); Stephen Bryan Avery, Wauwatosa, WI (US); Michael D. Marshall, Wauwatosa, WI (US); Matthew Mergener, Wauwatosa, WI (US)

(73) Assignee: Briggs & Stratton, LLC, Wauwatosa, WI (US)

(21) Appl. No.: 18/994,836

(22) PCT Filed: Jul. 17, 2023
(86) PCT No.: PCT/US2023/027898

§ 371 Date: Jan. 15, 2025

Related U.S. Application Data
(60) Provisional application No. 63/389,597, filed on Jul. 15, 2022.

(51) Int. Cl. H02J 7/00; A01D 34/00; A01D 34/78; A01D 69/02; A01D 101/00

(52) U.S. Cl. CPC H02J 7/0047; A01D 34/006; A01D 34/78; A01D 69/02; H02J 7/00032; H02J 7/0063; A01D 2101/00

(57) ABSTRACT

A lawn mower includes a drive wheel, a mowing deck including a cutting blade, a wheel motor operable to rotate the drive wheel, a cutting blade motor operable to rotate the cutting blade, and a battery system. The battery system includes a battery configured to power the wheel motor and the cutting blade motor and a battery controller communicably coupled to the battery. The battery controller includes one or more processors and memory storing instructions that, when executed by the one or more processors, cause the one or more processors to determine an electric current threshold for the battery, broadcast a message comprising the electric current threshold, compare an actual electric current of the battery to the electric current threshold, and adjust an operation of the battery system in response in response to determining that the actual electric current of the battery exceeds the electric current threshold for a predetermined amount of time.

### CROSS-REFERENCE TO RELATED PATENT APPLICATION

This application claims the benefit of and priority to U.S. Provisional Patent Application No. 63/389,597 filed Jul. 15, 2022, the entire disclosure of which is incorporated by reference herein.

### BACKGROUND

The present disclosure generally relates to systems and methods for controlling the operation of a battery-controlled vehicle. Outdoor power equipment (e.g., lawn mowers, riding tractors, etc.) may, for example use a battery to power an implement, such as a rotary blade of a lawn mower and/or a drivetrain of the outdoor power equipment.

### SUMMARY

One implementation of the present disclosure is a lawn mower including a drive wheel, a mowing deck including a cutting blade, a wheel motor operable to rotate the drive wheel, a cutting blade motor operable to rotate the cutting blade, and a battery system. The battery system includes a battery configured to power the wheel motor and the cutting blade motor and a battery controller communicably coupled to the battery. The battery controller includes one or more processors and memory storing instructions that, when executed by the one or more processors, cause the one or more processors to determine an electric current threshold for the battery, broadcast a message comprising the electric current threshold, compare an actual electric current of the battery to the electric current threshold, and adjust an operation of the battery system in response in response to determining that the actual electric current of the battery exceeds the electric current threshold for a predetermined amount of time.

In some embodiments, the electric current threshold for the battery includes both a shutdown current threshold and a recommended current threshold and the message broadcast by the battery controller includes both the shutdown current threshold and the recommended current threshold.

In some embodiments, the battery controller includes a plurality of power maps, each power map of the plurality of power maps comprising a different value of the electric current threshold. In some embodiments, determining the electric current threshold includes obtaining a value of the electric current threshold from an active power map of the plurality of power maps.

In some embodiments, the lawn mower includes a vehicle controller communicably coupled to the battery controller and configured to operate the cutting blade motor and the wheel motor using the actual electric current from the battery. In some embodiments, the message broadcast by the battery controller is provided to the vehicle controller and includes at least one of a recommendation for the vehicle controller to reduce the actual electric current of the battery or a warning that the battery will be shut down if the actual electric current is not reduced. In some embodiments, the vehicle controller is configured to selectively disable or de-rate at least one of the cutting blade motor or the wheel motor in response to receiving the message from the battery controller.

In some embodiments, the electric current threshold for the battery includes a shutdown current threshold. In some embodiments, adjusting the operation of the battery system includes shutting down the battery in response to determining that the actual electric current of the battery exceeds the shutdown current threshold for the predetermined amount of time.

In some embodiments, the electric current threshold for the battery includes a recommended current threshold. In some embodiments, adjusting the operation of the battery system includes transitioning from a first power map to a second power map in response to determining that the actual electric current of the battery exceeds the recommended current threshold for the predetermined amount of time.

In some embodiments, the first power map includes a first value of the recommended current threshold, the second power map comprises a second value of the recommended current threshold different from the first value of the recommended current threshold, and transitioning from the first power map to the second power map comprises updating the recommended current threshold from the first value to the second value.

In some embodiments, the battery system includes a sensor configured to measure a transitory condition of the battery. The transitory condition may include at least one of a temperature of the battery, a state of charge of the battery, a voltage of the battery, or the actual electric current of the battery. In some embodiments, the battery controller is configured to dynamically update the electric current threshold for the battery based on a measured value of the transitory condition of the battery.

Another implementation of the present disclosure is a battery system including a battery including one or more battery cells configured to charge and discharge using electric current, a sensor configured to measure a transitory condition of the battery, and a battery controller communicably coupled to the battery and the sensor. The battery controller may include one or more processors and memory storing instructions that, when executed by the one or more processors, cause the one or more processors to determine an electric current threshold for the battery based on the transitory condition of the battery, broadcast a message including the electric current threshold, compare an actual electric current of the battery to the electric current threshold, and adjust an operation of the battery system in response in response to determining that the actual electric current of the battery exceeds the electric current threshold for a predetermined amount of time.

In some embodiments, the electric current threshold for the battery includes both a shutdown current threshold and a recommended current threshold. In some embodiments, the message broadcast by the battery controller comprises both the shutdown current threshold and the recommended current threshold.

In some embodiments, the message broadcast by the battery controller is provided to an application controller and includes at least one of a recommendation for the application controller to reduce the actual electric current of the battery or a warning that the battery will be shut down if the actual electric current is not reduced.

In some embodiments, the battery controller includes a plurality of power maps. Each power map of the plurality of power maps may include a different value of the electric current threshold. In some embodiments, determining the electric current threshold includes obtaining a value of the electric current threshold from an active power map of the plurality of power maps.

In some embodiments, the electric current threshold for the battery includes a shutdown current threshold. In some embodiments, adjusting the operation of the battery system includes shutting down the battery in response to determining that the actual electric current of the battery exceeds the shutdown current threshold for the predetermined amount of time.

In some embodiments, the electric current threshold for the battery includes a recommended current threshold. In some embodiments, adjusting the operation of the battery system includes transitioning from a first power map to a second power map in response to determining that the actual electric current of the battery exceeds the recommended current threshold for the predetermined amount of time.

In some embodiments, the first power map includes a first value of the recommended current threshold, the second power map includes a second value of the recommended current threshold different from the first value of the recommended current threshold, and transitioning from the first power map to the second power map includes updating the recommended current threshold from the first value to the second value.

In some embodiments, the transitory condition of the battery includes at least one of a temperature of the battery, a state of charge of the battery, a voltage of the battery, or the actual electric current of the battery. In some embodiments, the battery controller is configured to dynamically update the electric current threshold for the battery based on a measured value of the transitory condition of the battery.

Another implementation of the present disclosure is a method for operating a battery including one or more battery cells configured to charge and discharge using electric current. The method includes measuring a transitory condition of the battery, determining an electric current threshold for the battery based on the transitory condition of the battery, broadcasting a message including the electric current threshold, comparing an actual electric current of the battery to the electric current threshold, and adjusting an operation of the battery system in response in response to determining that the actual electric current of the battery exceeds the electric current threshold for a predetermined amount of time.

In some embodiments, the electric current threshold for the battery includes both a shutdown current threshold and a recommended current threshold. In some embodiments, the message broadcast by the battery controller comprises both the shutdown current threshold and the recommended current threshold.

In some embodiments, the electric current threshold for the battery includes a shutdown current threshold. In some embodiments, adjusting the operation of the battery system includes shutting down the battery in response to determining that the actual electric current of the battery exceeds the shutdown current threshold for the predetermined amount of time.

In some embodiments, the electric current threshold for the battery includes a recommended current threshold. In some embodiments, adjusting the operation of the battery system includes transitioning from a first power map to a second power map in response to determining that the actual electric current of the battery exceeds the recommended current threshold for the predetermined amount of time.

### BRIEF DESCRIPTION OF THE FIGURES

The disclosure will become more fully understood from the following detailed description, taken in conjunction with the accompanying figures.

FIG. 1 illustrates a schematic diagram of a battery and load control system, according to an exemplary embodiment.

FIG. 2 illustrates a schematic diagram of a battery controller and a vehicle controller of the battery and load control system of FIG. 1, according to an exemplary embodiment.

FIG. 3 is a schematic drawing of a riding mower utilizing the battery and load control system of FIG. 1, according to an exemplary embodiment.

FIG. 4 illustrates a graph of a current measurement for the battery and load control system of FIG. 1, according to an exemplary embodiment.

FIG. 5 illustrates a method for operating the battery and load control system of FIG. 1, according to an exemplary embodiment.

FIG. 6 illustrates a schematic diagram of a battery controller of the battery controller of FIG. 1, according to an exemplary embodiment.

FIG. 7 illustrates a method for operating the battery controller of FIG. 1, according to an exemplary embodiment.

FIG. 8 illustrates a method for operating the battery controller and vehicle controller of FIG. 1, according to an exemplary embodiment.

FIG. 9 illustrates a method for operating the battery controller and memory of FIG. 1, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

The figures generally describe systems and methods for controlling the operation of a battery powered riding vehicle and/or piece of power equipment (e.g., lawn mowers, riding tractors, snow throwers, pressure washers, portable generators, tillers, log splitters, zero-turn radius mowers, walk-behind mowers, riding mowers, industrial vehicles such as forklifts, utility vehicles, etc.) based on messages received from a battery controller. In some embodiments, a riding vehicle may be powered by a battery which may be coupled to a battery controller. The battery controller may include one or more operating limits, which define acceptable values/value ranges for current and voltage measurements of the battery. The battery controller may be configured to determine a predetermined threshold for a current measurement and/or a voltage measurement associated with the battery. If the current measurement and/or voltage measurement is above the predetermined threshold for a predetermined amount of time (e.g., about 1 second, about 2 seconds, about 3 seconds, or between about 1 second and about 3 seconds), the battery controller may be configured to send a load control message that the current of the battery is above the threshold to a vehicle controller for the riding vehicle. In that case, the vehicle controller may then be configured to shed or disable a secondary or chore load associated with the vehicle in response to receiving the load control message. By shedding the secondary or chore load associated with the vehicle, the riding vehicle may be able to reserve the performance of the battery for primary functions including, but not limited to, moving the riding vehicle to a destination. In some embodiments, rather the disabling the secondary or chore load, that battery de-rates (e.g., reduces the current supplied to) the secondary or chore load to reserve performance of the battery for primary functions. In some embodiments, the vehicle controller may also be configured to deliver or display a notification to a user in response to receiving the load control message from the battery controller.

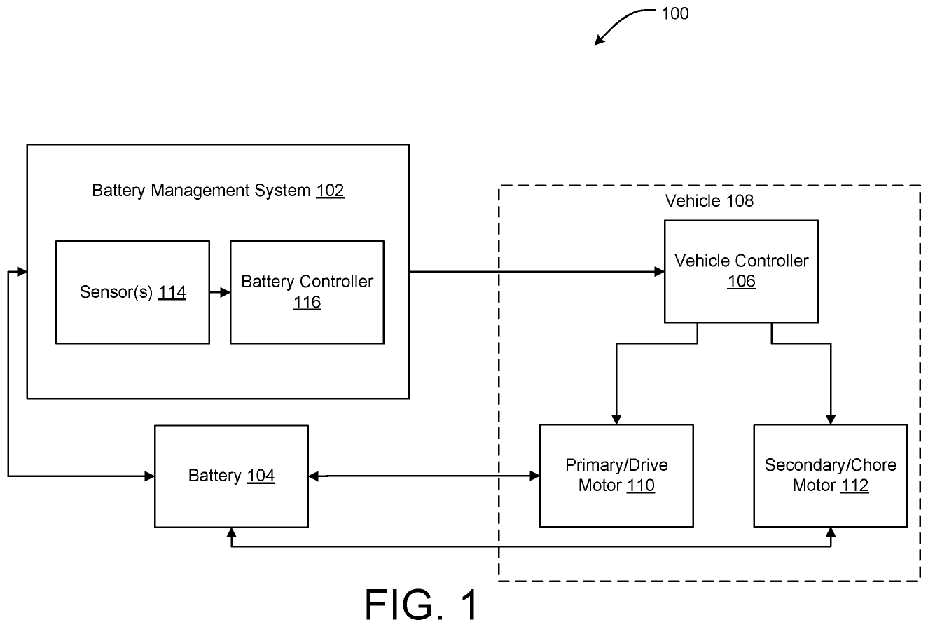

Referring now to FIG. 1, a battery and load control system 100 is shown according to an exemplary embodiment. The battery and load control system 100 includes a battery management system 102 coupled to a battery 104 and a vehicle controller 106 configured to control one or more components of a vehicle 108. The battery 104 is configured to provide electrical power to operate and propel the vehicle 106. More specifically, the battery 104 is electrically coupled to a primary/drive motor 110 and a secondary/chore motor 112, which are configured to drive and/or operate the vehicle 108. In some embodiments, the vehicle 108 may be a lawn mower/tractor, a riding tractors, snow throwers, pressure washers, portable generators, tillers, log splitters, zero-turn radius mowers, walk-behind mowers, riding mowers, industrial vehicles, such as forklifts, an ATV, a utility vehicle, forklift, or other similar battery powered riding vehicle. In some embodiments, the secondary or chore motor 112 may, for example, operate an implement, such as a rotary blade of a lawn mower, a pump of a pressure washer, the auger a snowthrower, or the alternator of a generator.

Although the battery 104 is shown in FIG. 1 as a single component, the battery 104 may include multiple battery packs connected in parallel to provide an output voltage. In some embodiments, the battery 104 may have a voltage rating of 36-48 volts with a capacity between 1.5 and 10 kilo-watt hours. The voltage ratings and power capacities described herein are only meant to be exemplary and the battery 104 can have an increased or decreased voltage rating or capacity than those disclosed herein. In some embodiments, the battery 104 may be comprised of lithium-ion battery cells or any other type of battery cells. For example, the battery 104 may be comprised of lithium-ion battery cells, including nickel, manganese, and cobalt (“NMC”) lithium-ion battery cells and lithium-iron phosphate (“LFP”) cells, or any other type of battery cells.

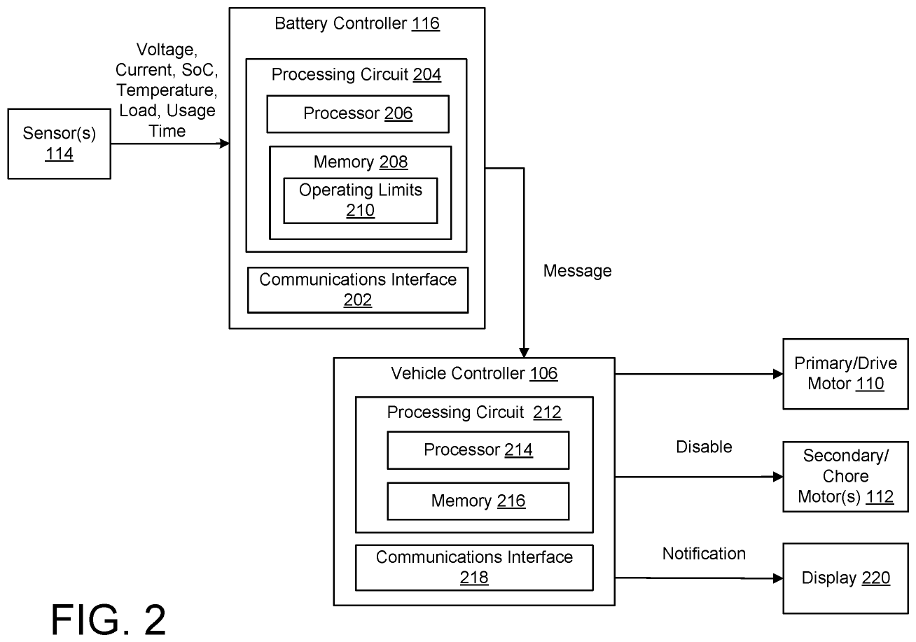

The battery 104 is coupled to the battery management system 102 and the battery management system 102 is configured monitor the state/health of the battery 104 and control the battery 104. The battery management system 102 includes one or more sensors 114 that are configured to monitor the state of the battery 104. More specifically, the one or more sensors 114 may be include a voltage sensor that is configured to collect a voltage measurement of the battery 104. In some embodiments, the one or more sensors 114 may include a current sensor that is configured to collect a current measurement of the battery 104. The voltage measurements may include an overall voltage measurement for the battery 104 or one or more cells or cell module assemblies that make up the battery 104. The current measurement may include a regeneration current and/or a discharge current for the battery 104. In some embodiments, the one or more sensors 114 may include a temperature sensor configured to measure the temperature of the battery 104. The one or more sensors 114 may also include one or more sensors configured to measure the state of charge of the battery 104, the load on the battery 104, and the usage time since a load has been delivered to the battery 104. The one or more sensors 114 may be communicably coupled to the battery controller 116, and the battery controller 116 is configured to utilize the information received from sensors 114 (e.g., voltage measurements, current measurements, temperature measurements, etc.) to control operation of the battery 104 and send messages to the vehicle controller 106 based on the information received from the sensors 114. In some embodiments, the battery controller 116 and the vehicle controller 106, and their respective functionalities, may be included in a single controller which controls both the battery 104 and the one or more motor(s) associated with the vehicle 108 (e.g., primary motor 110 and secondary motor 112). In such an embodiment, the single controller may be configured to receive battery information from the sensors 114 and lower the power output of the battery based this information to reserve the performance of the battery for primary functions including, but not limited to, moving the riding vehicle to a destination. The controller may also shed the secondary or chore load associated with the vehicle 108. The battery controller 116 and the vehicle controller 106 are explained in more detail below with respect to FIG. 2.

Referring now to FIG. 2, a schematic diagram of the battery controller 116 and the vehicle controller 106 is shown according to an exemplary embodiment. The battery controller 116 is configured to monitor the state of the battery 104 and control operation of the battery 104 and send messages to the vehicle controller 106 based on the state of the battery 104. More specifically, the battery controller 116 is configured to compare one or more voltage measurements and/or current measurements of the battery 104 to one or more operating limits to determine if the current and/or voltage measurements fall within a predetermined range. Based on this determination, the battery controller 116 may send one or more messages to the vehicle controller 106 and/or control the operation of battery 104. As explained above, the battery controller 116 is communicably coupled to the sensors 114, which are configured to provide information about the battery to the battery controller 116. The battery information may include, but is not limited to, the state of charge the battery 104, voltage measurement(s), current measurement(s), load measurements, temperature of the battery, and usage time for the battery 104. The battery controller 116 may include a communications interface 202 that is configured to facilitate communication between the battery controller 116 and other components of the battery and load control system 100. For example, the communications interface 202 may be configured to facilitate communication between the sensors 114 and the battery controller 116. As another example, the communications interface 202 may be configured to facilitate communication between the vehicle controller 106 and the battery controller 116. The communications interface 202 can be or include wired or wireless communications interfaces (e.g., jacks, antennas, transmitters, receivers, transceivers, wire terminals, etc.) for conducting data communications between the battery controller 116 and other components of the battery and load control system 100. In various embodiments, communications via the communications interface 202 can be direct (e.g., local wired or wireless communications) or via a communications network (e.g., a WAN, the Internet, a cellular network, a CAN, etc.).

The battery controller 116 includes a processing circuit 204 having a processor 206 and memory 208. The processing circuit 204 may be structured or configured to execute or implement the instructions, commands, and/or control processes described herein with respect to the battery controller 116. The depicted configuration represents the processing circuit 204 as instructions stored in non-transitory machine or computer-readable media. However, as mentioned above, this illustration is not meant to be limiting as the present disclosure contemplates other embodiments the processing circuit 204 is configured as a hardware unit. All such combinations and variations are intended to fall within the scope of the present disclosure.

The processor 206 may be one or more of a single- or multi-chip processor, a digital signal processor (DSP), an application specific integrated circuit (ASIC), a field programmable gate array (FPGA), or other programmable logic device, discrete gate or transistor logic, discrete hardware components, another type of suitable processor, or any combination thereof designed to perform the functions described herein. In this way, the processor 206 may be a microprocessor, a state machine, or other suitable processor. The processor 206 also may be implemented as a combination of computing devices, such as a combination of a DSP and a microprocessor, a plurality of microprocessors, one or more microprocessors in conjunction with a DSP core, or any other such configuration. The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure. In another configuration, the processing circuit 204 may be embodied as one or more circuitry components including, but not limited to, processing circuitry, network interfaces, peripheral devices, input devices, output devices, etc. In some embodiments, the processing circuit 204 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the processing circuit 204 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The memory 208 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory 208 may be communicably coupled to the processor 206 to provide computer code or instructions to the processor 206 for executing at least some of the processes described herein. Moreover, the memory 208 may be or include tangible, non-transient volatile memory or non-volatile memory. Accordingly, the memory 208 may include database components, object code components, script components, or any other type of information structure for supporting the various activities and information structures described herein.

In the illustrated embodiment, the memory 208 may store or calculate one or more operating limits 210. In some embodiments, the operating limits 210 (e.g., lookup tables) are each defined as a function of a state of charge of the battery 104 and a temperature of the battery 104 for various loads or time of usage for the battery 104. In some embodiments, the operating limits are generated by collecting and processing (e.g., filters, transforms, etc.) various battery sensor data (e.g., voltage measurements, current measurements, temperature measurements), performing calculations on the sensor data (e.g., linearize a nonlinear voltage curve into a SOC with Coulomb counting), and providing battery operational conditions to optimize the use of the battery based on recommended or predetermined performance values and battery parameters (e.g., maintain maximum performance while maintaining battery safety, allow the end-application to deplete (apply/use up) the useful energy of the battery pack before over-temperature, under/over-voltage events occur, and balance cycle life (health) with machine performance by implementation of a real time duty-cycle calculator to adjust allowable current levels, etc.). In some embodiments, the operating limits 210 are iterated between based the measured values for the state of charge, the temperature, and the load or time of usage of the battery 104. In some embodiments, the operating limits 210 include separate sets of maps defining a current limit or threshold for when the battery 104 is charging and when the battery 104 is discharging. In other embodiments, the operating limits 210 include separate sets of maps defining a power limit or threshold for when the battery 104 is charging and when the battery 104 is discharging. In general, the operating limits 210 generate a predefined operating limit or threshold for current, voltage, or power that is calculated (e.g., in real time) by the battery controller 116. The battery controller 116 may compare the battery information received from the sensors 114 to the operating limits 210 stored in the memory 208 to determine whether the voltage measurements and/or current measurements of the battery 104 fall within a predetermined threshold (e.g., the limits defined by the operating limits 210) for a predetermined amount of time (e.g., about 1 second, about 2 seconds, about 3 seconds, or between about 1 second and about 3 seconds). If the measurements fall within the predetermined thresholds, then the battery controller 116 may send a message that battery 104 is operating within acceptable operating conditions (e.g., temperature, voltage measurements, current measurements, etc.) and disconnection between the components of the vehicle 108 (e.g., the primary drive motor 110 and the secondary chore motor 112) is not imminent. However, if the measurements do not fall within the predetermined thresholds for the predetermined amount of time, the battery controller 116 may send a load control message to vehicle controller 106 based on which measurement does not fall within the predetermined thresholds for the predetermined amount of time.

The vehicle controller 106 is configured to receive a message from the battery controller 116 based on the state of the battery 104. As explained above, the battery controller 116 is configured to provide this message to the vehicle controller 106. In some embodiments, the vehicle controller 106 includes a communications interface 218 that is configured facilitate communication between the vehicle controller 106 and battery controller 116. For example, the vehicle controller 106 may receive the load control message from the battery controller 116 through the communications interface 218. The communications interface 218 can be or include wired or wireless communications interfaces (e.g., jacks, antennas, transmitters, receivers, transceivers, wire terminals, etc.) for conducting data communications between the vehicle controller 106 and other components of the battery and load control system 100 or the vehicle 108. In various embodiments, communications via the communications interface 218 can be direct (e.g., local wired or wireless communications) or via a communications network (e.g., a WAN, the Internet, a cellular network, a CAN, etc.). The messages sent by the battery controller 116 and received by vehicle controller 106 are explained in Table 1 below. In some embodiments, the messages are communicated over a CAN bus.

TABLE 1
Battery Message Values and Meanings

| Bit Value | |
|---|---|
| Message | Message Meaning |
| 0000 | Battery measurements within the predetermined range. |
| 0001 | Battery pack voltage below minimum acceptable level for |
| | predetermined amount of time |
| 0010 | Battery pack voltage above maximum acceptable level for |
| | predetermined amount of time |
| 0011 | Module voltage below minimum acceptable level for |
| | predetermined amount of time |
| 0100 | Module voltage above maximum acceptable level for |
| | predetermined amount of time |
| 0101 | Cell voltage below minimum acceptable level for |
| | predetermined amount of time |
| 0110 | Cell voltage above maximum acceptable level for |
| | predetermined amount of time |
| 0111 | Battery pack current above maximum acceptable level for |
| | predetermined amount of time |

Similar to the battery controller 116, the vehicle controller 106 also comprises a processing circuit 212 similar to the processing circuit 204. The processing circuit 212 includes a processor 214 and memory 216 similar to the processor 206 and the memory 208. The processing circuit 204 may comprise many of the same components and features of processing circuit 204, which are explained in more detail above and will not be reiterated here for the sake of brevity. The vehicle controller 106 is configured to control the operation of the primary/drive motor 110 and the secondary/chore motor(s) 112 based on the message received from the battery controller 116. For example, if the vehicle controller 106 receives a load control message from the battery controller 116 indicating that the current of the battery 104 (e.g., as measured by the current sensor) is above a predetermined threshold level (e.g., as determined by the operating limits 210) for a predetermined amount of time, then the vehicle controller 106 may disable or de-rate the secondary/chore motor(s) 112 and cause a notification to be displayed to the user. In some embodiments, the notification to the user may be displayed on a display 220 associated with the vehicle 108 or a user device associated with the user (e.g., a tablet or personal device). The notification displayed is related to the type of message received by the vehicle controller 106. For example, if the vehicle controller 106 receives a load control message relating to the current being above the predefined threshold for the predetermined amount of time, the notification displayed may be “battery pack current above maximum acceptable level for predetermined amount of time.”

In some embodiments, each of the secondary/chore motor(s) 112 may include a motor controller that is configured to control the operation thereof, rather than or in addition to the vehicle controller 106. The motor controllers may be in communication with the battery controller 116 and be configured to receive the load control message from the battery controller 116. In response to receiving the load control message from the battery controller 116, the motor controllers may be configured to de-rate or disable the individual secondary/chore motors 112.

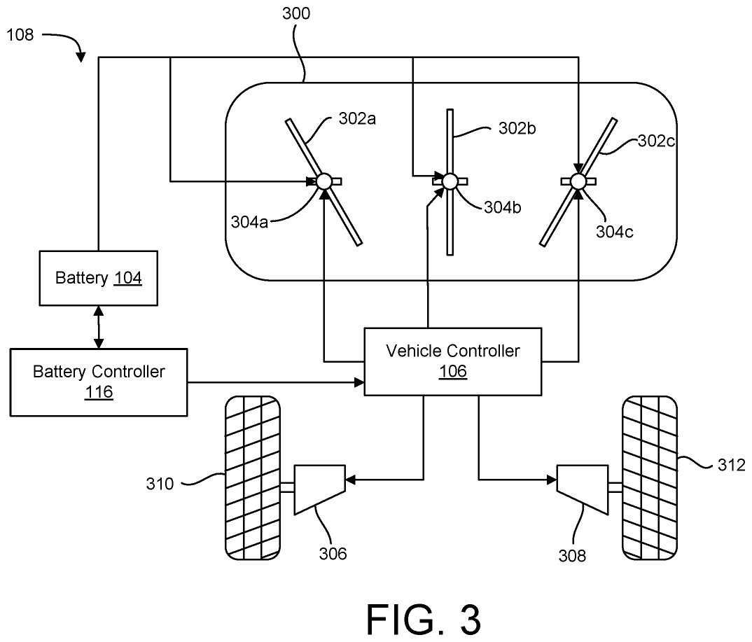

Referring now to FIG. 3, a schematic illustration of an electric drivetrain for the vehicle 108 in form of a lawn mower is shown, according to an exemplary embodiment. In some embodiments, the vehicle 108 may be a mower which includes a mower deck 300. In some embodiments, the lawn mower may be a ZTR mower. ZTR mowers are a type of lawn mowing equipment which include a pair of independently driven rear wheels. The independent drive of the rear wheels allows the ZTR mower to be extremely maneuverable and operable at relative high mowing speeds. The mower deck 300 encloses three sets of cutting blades 302 (302a, 302b and 302c). The cutting blades are oriented such that the cutting blade 302a is an outer cutting blade on a left side of the mower deck 300 and the cutting blade 302c is an outer cutting blade on a right side of the mower deck 300. In the embodiment shown, a single center cutting blade 302b is positioned between the pair of outer cutting blades 302a and 302c. However, additional cutting blades can be included in the mower deck between the outer cutting blades.

Each of the cutting blades 302 is driven by electric cutting blade motors 304 (304a, 304b and 304c). The cutting blade motors 304 are each driven by the battery 104 that is connected to the cutting blade motors 304. The vehicle 108 includes five separate and independent electric motors. In some embodiments, the vehicle 108 includes more or less than five separate and independent electric motors. In the illustrated embodiment, three of the electric motors 304 are used to rotate the cutting blades 302 while electric wheel motors 306 and 308 are used to independently operate the rear drive wheels 310 and 312. Specifically, the vehicle 108 illustrated in FIG. 3 includes a first rear wheel drive motor 306 and a second rear wheel drive motor 308. The first wheel motor 306 drives rotation of a first rear drive wheel 310, while the second wheel motor 308 drives the rotation of a second rear drive wheel 312. Both of the first and second wheel motors 306 and 308 are powered by the battery 104 through the vehicle controller 106.

The rotational speed and rotational direction of each of the motors 304, 306 and 308 may be controlled through separate control signals, or individual motor controllers, since the motors operate independently from each other. In some embodiments, the vehicle controller 106 may shed the load of the electric motors 304 if the voltage measurements, current measurements, or temperature measures are not within a predetermined threshold for a predetermined amount of time. For example, the vehicle controller 106 is in communication with the electric blade motors 304 and the electric wheel motors 306, 308. The battery controller 116 is configured to determine a current threshold for the battery 104 based on the operating limits 210, and compare a current magnitude of the battery 104 (e.g., as measured by the current sensor) to the current threshold defined by the operating limits 210. The battery controller 116 is also configured to monitor the battery 104 to determine a current magnitude of the battery 116 and compare the current magnitude of the battery 116 to the current threshold to determine whether the battery 104 is operating within the ranges of the current threshold. If the battery controller 116 determines that the current magnitude is above the current threshold, the battery controller 116 sends a message to the vehicle controller 106 that the current magnitude is above the current threshold. In response to this message, the vehicle controller 106 (or the motor controllers) may disable or de-rate one or more of the electric blade motors 304a, 304b, 306c to stop rotating the cutting blades 302a, 302b, and 302c.

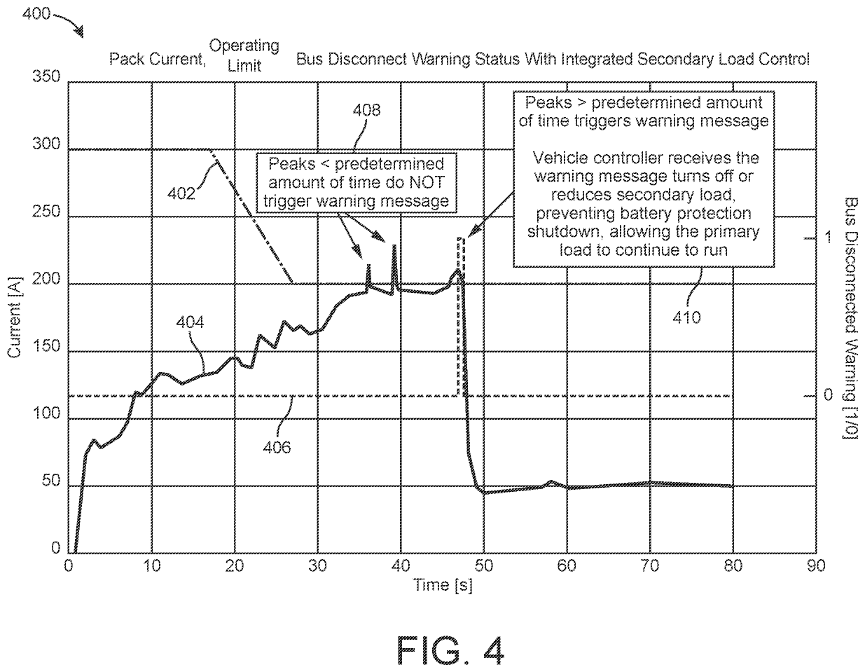

Referring now to FIG. 4, a graph 400 of a current measurement for the battery and load control system of 100 is shown according to an exemplary embodiment. The x-axis for the graph 400 is time in seconds while the y-axis is current in amperes. The graph 400 includes a predetermined current threshold 402 based on the operating limits 210, the current measurement of the battery 404 (e.g., as measured by a current sensor), and an on/off status of the load control message 406 sent from the battery controller 116 to the vehicle controller 106. Graph 400 shows the use case in which load shedding is done based on the current measurement of the battery 404 being above the predetermined current threshold 402 for a predetermined period of time in an attempt to only provide power for primary operations (e.g., the drive motor 110) and prolong the life of a battery associated with the vehicle. At graph portion 408, when the current measurement of the battery 404 is above predetermined current threshold 402 for periods of time less than a predetermined amount of time (e.g., less than about 1 second, about 2 seconds, or about 3 seconds), the load control message status 406 remains inactive or off. However, if the current measurement 404 is above the predetermined current threshold 402 for the predetermined amount of time (e.g., about 1 second, about 2 seconds, about 3 seconds, or between about 1 second and about 3 seconds), the battery controller 116 may cause the status of the load control message to become active or turn on, as shown in portion 410 of the graph 400. The status of the load control message switching to active indicates that the battery controller 116 sends the load control message to the vehicle controller 106. The load control message may then be received by the vehicle controller 106, which may shed one or more secondary/chore loads by disabling the secondary or chore motor 112 (or an electric cutting blade motor 304) in response to receiving the load control message from the battery controller 116. In this way, the battery 104 is allowed to keep powering primary operations (e.g., powering the primary/drive motor 110, or the electric drive motors 306, 308).

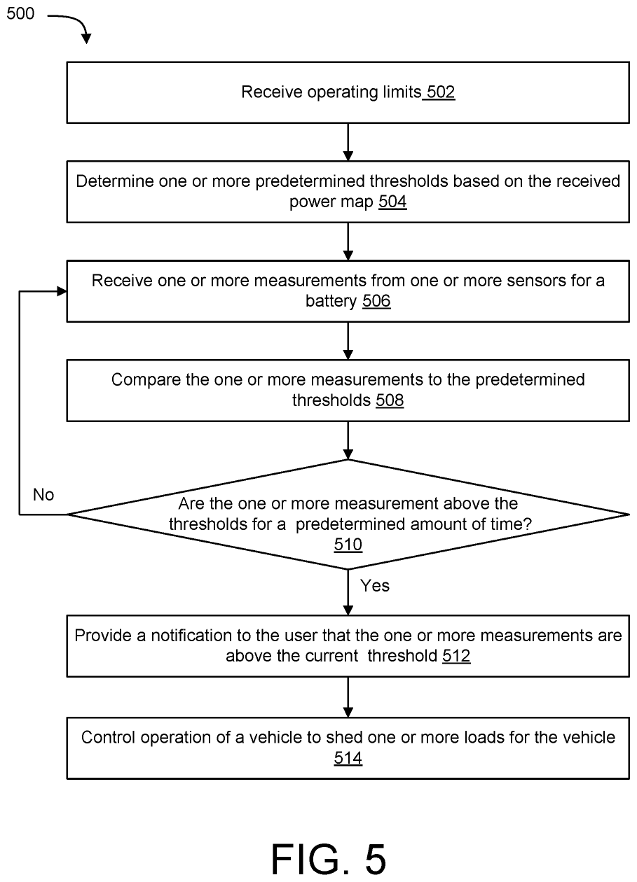

Referring now to FIG. 5, a method 500 for operating the battery and load control system 100 is shown, according to an exemplary embodiment. The method 500 may be implemented, at least in part, by the battery controller 116 and/or the vehicle controller 106 (or a motor controller). The method 500 begins with at step 502 with the battery controller 116 receiving one or more operating limits, which may be predetermined or calculated in real-time by the battery controller 116 or another controller. The operating limits define acceptable operating ranges or limits for current, voltage, and/or power of the battery 104 during operation, which may be determined based a state of charge, a temperature, and a load or usage time of the battery 104. At step 504, the battery controller 116 is configured to determine one or more thresholds for the battery 104 based on the operating limits received at step 502. The thresholds may include a voltage threshold, a current threshold, and/or a power threshold.

At step 506, the battery controller 116 receives one or more measurements from one or more sensor associated with the battery 104. The one or measurements associated with the one or more sensors for the battery 104 may include a voltage measurement and/or a current measurement. At step 508, the battery controller 116 compares the one or more measurements received at step 506 to the predetermined thresholds determined at step 504. In some embodiments, the battery controller 116 compares a current magnitude of the battery 104 to the current threshold defined by the operating limits. At step 510, the battery controller 116 determines if the one or more measurements are above the predetermined thresholds for a predetermined amount of time. The predetermined amount of time may be about 1 second, about 2 seconds, about 3 seconds, or between about 1 second and about 3 seconds. If the one or more measurements are not above the thresholds for a predetermined amount of time, the method 500 begins again starting at step 506. If one or more of the measurements are above the predetermined thresholds for a predetermined amount of time, the method proceeds to step 512 where the battery controller 116 sends a load control message to the vehicle controller 106 (or a motor controller) notifying the vehicle controller 106 that a battery measurement is above the threshold. In response to receiving the load control message, the vehicle controller 106 provides a notification to a user that the one or more measurements are above the predetermined thresholds at step 512. Substantially simultaneously with providing the notification at step 512, the vehicle controller 106 (or a motor controller) also controls the operation of the vehicle 108 to shed one or more loads for the vehicle 108 in response to receiving the message at step 514. For example, the vehicle controller 108 may shed a secondary/chore load of the secondary/chore motor 112 or the electric cutting blade motors 304 by disabling or de-rating the secondary/chore motor 112 or the electric cutting blade motors 304.

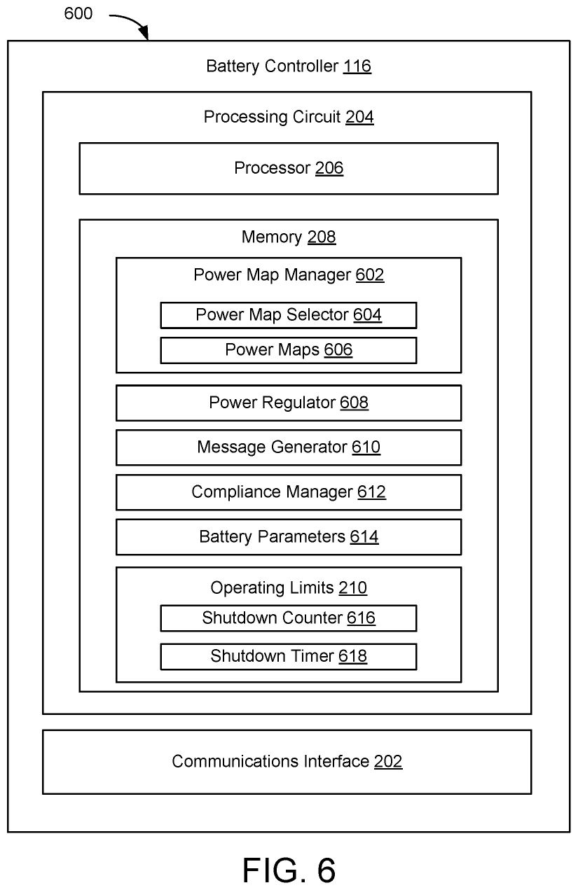

Referring now to FIG. 6, a schematic diagram of the battery controller 116 is shown according to an exemplary embodiment. The battery controller 116, as described prior, is configured to monitor the state of the battery 104, control operation of the battery 104, and send messages to the vehicle controller 106 based on the state of the battery 104. To avoid repetitiveness, many features and functionality of the battery controller 116 shown in FIG. 6 may be the same or similar to the features described elsewhere in the present disclosure.

As described in a previous embodiment, the memory 208 may include one or more devices (e.g., RAM, ROM, Flash memory, hard disk storage) for storing data and/or computer code for completing or facilitating the various processes, layers and modules described in the present disclosure. The memory 208 may be communicably coupled to the processor 206 to provide computer code or instructions to the processor 206 for executing at least some of the processes described herein. Moreover, the memory 208 may be or include tangible, non-transient volatile memory or non-volatile memory. Accordingly, the memory 208 may include database components, object code components, script components, or any other type of information structure for supporting the various activities and information structures described herein.

In the illustrated embodiment, the memory 208 may contain a power map manager 602. The power map manager 602 can be configured to monitor the battery current (e.g., charging or discharging current) and/or other battery parameters 614, select a power map 606, and operate the battery 104 according to the selected power map. In some embodiments, the power map manager 602 may be structured or configured to direct the instructions, commands, and/or configurations described herein with respect to the battery controller 116. The depicted configuration represents the power map manager 602 as computer readable instructions located within the memory 208. The power map manager 602 may include selection instructions and a collection of power configurations specified by a data structure (e.g., list, array, hash table).

In the illustrated embodiment, the power map manager 602 may contain a power map selector 604. In some embodiments, the power map selector 602 may be structured or configured to request a specific configuration of power, dependent upon the factors and scenario described herein. The power map selector 604 may make these requests by an instruction, command, and/or configuration directed by the power map manager 602, where the power map selector 604 will request the desired configuration in the collection of power maps 606 within the power map manager 602.

In the illustrated embodiment, the power map manager 602 may contain power maps 606. In some embodiments, the power maps 606 may be structured or configured to maintain a collection of power configurations specified by the capabilities of the battery controller 116. The collection of power maps 602 may be stored as a database or within a data structure (e.g., list, array, hash table, and set). The power maps 606 may contain several power configurations which correspond to various external stimuli and capabilities of the machine currently in operation. The power configurations may contain specific data for several power thresholds, voltage thresholds, and current thresholds to be set at the time of the selection of said power map 606. For example, each power map 606 may include a recommended battery current threshold which specifies a recommended electric current limit (e.g., maximum charging current, maximum discharging current) for the battery 104 when the corresponding power map 606 is active. Different power maps 606 may have different recommended current thresholds, with some of the recommended current thresholds being higher/lower than others. Each power map 606 may further include a battery shutdown threshold which specifies an electric current limit for the battery 104 which will cause the battery controller 116 to shut down the battery 104 if the shutdown current limit is exceeded for a required amount of time. The power map selector 604 may select a given power map 606 and transition between different power maps 606, dependent upon the present values of the electric current, voltage, power, temperature, or other dynamic (e.g., measured) or static values of the battery parameters 614.

The power map selector 604 may be configured to select a particular power map 606 and transition between the power maps 606 based on a variety of factors. In some embodiments, the power map selector 604 may operate as a finite state machine and may transition between various power maps 606 (e.g., states) based on various state transition conditions. The state transition conditions can include, for example, comparing the monitored battery parameters 614 to various thresholds (e.g., comparing the present values of the battery electric current, power, voltage, state of charge, temperature, or other battery parameters 614 to corresponding thresholds) to determine whether a given condition is satisfied. In some embodiments, the power map selector 604 determines an amount of time that has elapsed since the active power map 606 was selected or activated or an amount of time that has elapsed since the battery current has exceeded the recommended current threshold specified by the active power map 606. The power map selector 604 may determine that the active power map 606 should be deactivated and that a different power map 606 should be activated if the battery current remains above the recommended current threshold for a specified amount of time.

To illustrate one example of the functions performed by the power map selector 604, the power map selector 604 may a first (e.g., initial) power map 606 when the battery 104 first begins charging or discharging (e.g., after a period of non-use). The first power map 606 may have a first recommended current threshold and a first battery shutdown threshold. The power map selector 604 may monitor the battery parameters 614 (e.g., the charging or discharging current, power, state of charge, etc.) while the first power map 606 is active and determine whether the electric current into or out of the battery 104 exceeds the first recommended current threshold. If the electric current exceeds the first recommended current threshold for a given amount of time, the power map selector 604 may deactivate the first power map 606 and activate a second power map 606.

The second power map 606 may have a second recommended current threshold (e.g., higher than the first recommended current threshold) and a second battery shutdown threshold (e.g., the same as or higher than the first battery shutdown threshold). The power map selector 604 may monitor the battery parameters 614 while the second power map 606 is active and determine whether the electric current into or out of the battery 104 exceeds the second recommended current threshold. If the electric current exceeds the second recommended current threshold for a given amount of time, the power map selector 604 may deactivate the second power map 606 and activate a third power map 606. The third power map 606 may have a third recommended current threshold (e.g., higher than the first and second recommended current thresholds) and a third battery shutdown threshold (e.g., the same as or higher than the first and second battery shutdown thresholds).

The power map selector 604 may repeat this process for any number of power maps 606, with the power map selector 604 transitioning into power maps 606 with successively higher recommended current thresholds if the current threshold of the active power map 606 is exceeded for a predetermined amount of time. Similarly, the power map selector 604 may transition into power maps 606 having lower recommended current thresholds if the electric current into or out of the battery 104 is below a predetermined current limit (e.g., a minimum threshold) for a predetermined amount of time.

In the illustrated embodiment, the memory 208 may contain a power regulator 608. In some embodiments, the power regulator 608 may be structured or configured to receive instructions, commands, and/or configurations established by the power map manager 602. The power regulator 608 may be structured or configured to send information in the form of commands, instructions, and/or configurations to the message generator 610, to send the generated messages to a vehicle controller (e.g., a vehicle controller 116).

In the illustrated embodiment, the memory 208 may contain a message generator 610. In some embodiments, the message generator 610 may be structured or configured to generate readable instructions, commands, and/or configurations for, but not limited to, a vehicle controller (e.g., vehicle controller 116). The messages generated by the message generator 610 may be sent over the communications interface 202 to the vehicle controller 106 to adjust the current, voltage, and or power sent to one or more motors (e.g., Primary/Drive Motor, Secondary/Chore Motor). The messages sent by the message generator 610 may include the values of the recommended current threshold and/or the battery shutdown threshold for the active power map 606. For example, the message generator 610 may interact with the power map manager 602 to determine which of the power maps 606 is currently active and may read the recommended current threshold and/or the battery shutdown threshold from the active power map 606. The message generator 610 may then generate and send a message to the vehicle controller 116 which includes the present values of the recommended current threshold and/or the battery shutdown threshold.

In the illustrated embodiment, the memory 208 may contain a compliance manager 612. In some embodiments, the compliance manager 612 may be structured or configured to keep a record of events, which show noncompliance. The record of events may be stored as a database or a data structure (e.g., list, array, hash table). Noncompliance events occur when the battery goes beyond normal operating limits (e.g., the recommended current thresholds, the battery shutdown thresholds, etc.) defined within the memory 208 (e.g., by the power maps 606). The record of noncompliance events may be exported to some form of external client device (e.g., computer, laptop, USB drive, etc.) to be processed and interpreted further.

In the illustrated embodiment, the memory 208 may contain battery parameters 614. The battery parameters 614 may include any permanent or transient parameters or variables that characterize the battery 104, the current state of the battery 104, or the operation thereof. For example, the battery parameters 614 may include a set of fixed attributes of the battery such as the type of battery cells, number of battery cells, battery model information, design parameters (e.g., design voltage, current, power, etc.) or other information that is not expected to change as the battery 104 is operated. The battery parameters 614 may include transient parameters or variables which can be updated based on measured, estimated, or calculated conditions during operation of the battery 104. For example, the battery 104 and/or the system 100 may include several sensors 114 as previously described such as a temperature sensor configured to measure a temperature of the battery 104, an electric current sensor configured to measure an electric current into or out of the battery 104, or any other type of sensor which can be used to measure present conditions of the battery 104. In some embodiments, the battery parameters 614 may be structured or configured to store the current information regarding the battery, which include, but are not limited to the state of charge, temperature, load, usage time, and voltage. The battery parameters 614 may be dynamically updated dependent upon the factors listed above, for the battery controller 116 to use to determine the nominal operating limits 210 of the battery.

As described in a previous embodiment, the memory 208 may store or calculate one or more operating limits 210. The operating limits 210 may include a shutdown counter 616 and a shutdown timer 618. The shutdown timer 618 may include value, which varies dependent upon the specific use of the battery controller 116 dependent upon the machine. The operating limits may include a shutdown counter 616, which may increment until it reaches the value of the shutdown timer 618. The shutdown counter 616 may increment by an integer value of one at each iteration of a predetermined amount of time elapsing (e.g., seconds, milliseconds, nanoseconds, etc.).

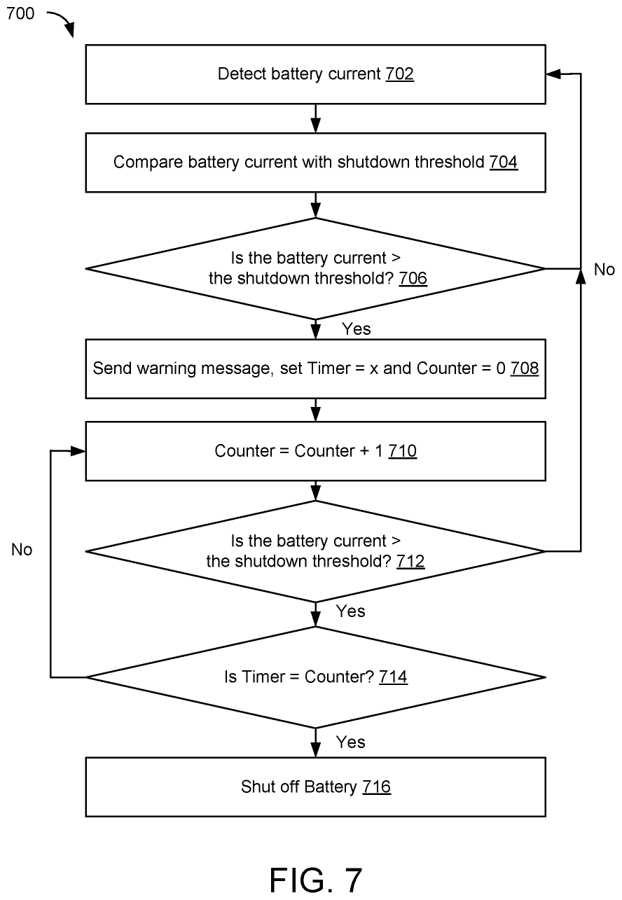

Referring now to FIG. 7, a method 700 for operating a battery controller (e.g., battery controller 116) is shown, according to an exemplary embodiment. The battery controller 116 may implement the method 700, at least in part. The method 700 begins at step 702 with the battery controller 116 receiving the battery current from a battery current sensor or other component configured to measure or estimate the electric current into or out of the battery 104. The battery current may be updated or calculated in real-time by the battery controller 116. The battery current may be determined from a real-time state of charge, a real-time temperature, and a real-time load or usage time of the battery 104. At step 704, the battery controller 116 will receive operating limits (e.g., operating limits 210) from memory (e.g., memory 208). The operating limits 210 define acceptable operating ranges or limits for current, voltage, and/or power of the battery 104 during operation, which may be determined, based a state of charge, a temperature, and a load or usage time of the battery 104. In some embodiments, the operating limits 210 are provided by the active power map 606 for the battery 104 and may include a recommended current threshold and/or a battery shutdown threshold. The operating limits 210 may contain predetermined thresholds (e.g., shutdown thresholds) to ensure the life of the battery 104 is not compromised form prolonged use beyond the shutdown threshold. At step 704, the battery controller 116 will compare the real-time battery current from step 702 with the shutdown threshold from the operating limits 210 and compare the values of each current to determine the optimal or excessive use of the battery 104.

At step 706, the battery controller 116 determines if the battery current is above the shutdown threshold. If the battery current is not above the shutdown threshold, the method 700 begins again starting at step 702. If the battery current is above the shutdown threshold, the method 700 proceeds to step 708 where the battery controller 116 send a message to a vehicle controller (e.g., vehicle controller 106), shown on a display (e.g., display 220), notifying the vehicle controller 106 and the user that the battery current is above the shutdown threshold. A counter (e.g., shutdown counter 618) initializes to a value of zero and will increment to the predetermined value stored in a timer (e.g., shutdown timer 616). At step 710, the counter will increase by one to indicate one unit of time elapsing and proceed to step 712. If the battery current is no longer above the shutdown threshold, the method 700 will proceed to step 702. If the battery current is above the shutdown threshold, the method 700 will proceed to step 714. At step 714, the battery controller 116 will check if the value of the counter is the same as the timer. If the counter is not equal to the timer, the method 700 will proceed to step 710. If the counter is equal to the timer, the system 700 will proceed to step 716, and the battery 104 will shut off. In this regard, the method 700 will cause the battery 104 to shut off if the battery current exceeds the shutdown threshold for a predetermined amount of time.

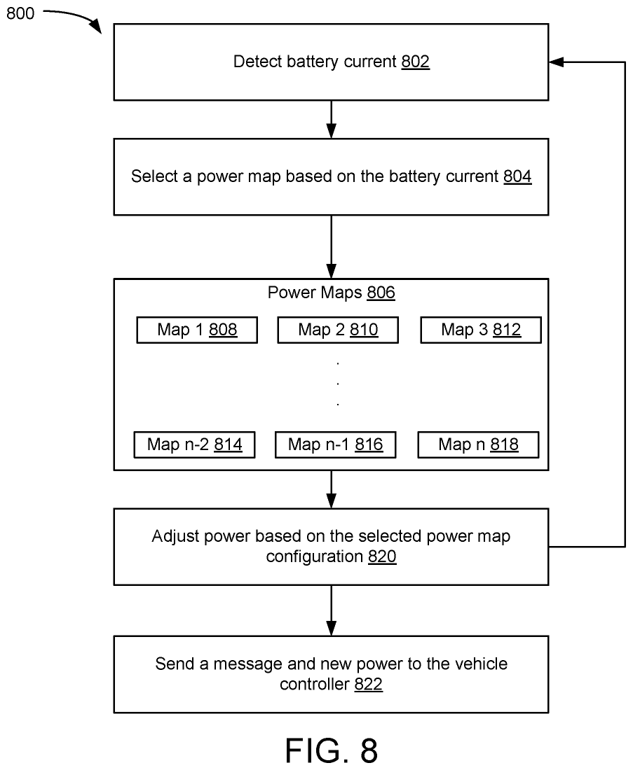

Referring now to FIG. 8, a method 800 for operating the battery controller 116 and vehicle controller 106, according to an exemplary embodiment. The battery controller 116 and vehicle controller 106 may implement the method 700, at least in part. The method 800 begins at step 802 with the battery controller 116 receiving the battery current from a battery (e.g., battery 104), which is updated or calculated in real-time by the battery controller 116. The battery current may be determined from a real-time state of charge, a real-time temperature, and a real-time load or usage time of the battery 104. At step 804, the battery controller 116 will send the real-time current measurements to a power map manager (e.g., power map manager 602) to signal a power map selector (e.g., power map selector 604) to choose a desired power map (e.g., power map 606) to select the desired power map. At step 806, the power map selector 604 will choose the desired power map 606 from the collection of power maps (e.g., Map 1 808, Map 2 810, Map 3 812, . . . , Map n 818), contained within the power map manager 602. At step 820, a power regulator (e.g., power regulator 608) reads the desired power map 606. The power map 606 may contain specific parameters to reduce or increase the electric current, power or charge/discharge rate of the battery 104. The method 800 will start again at step 802 after updating the battery current to match the increase or decrease in power. The method 800 will proceed to step 822 and send a message with the new current and power parameters from the selected power map 806 to the vehicle controller 106 for distribution.

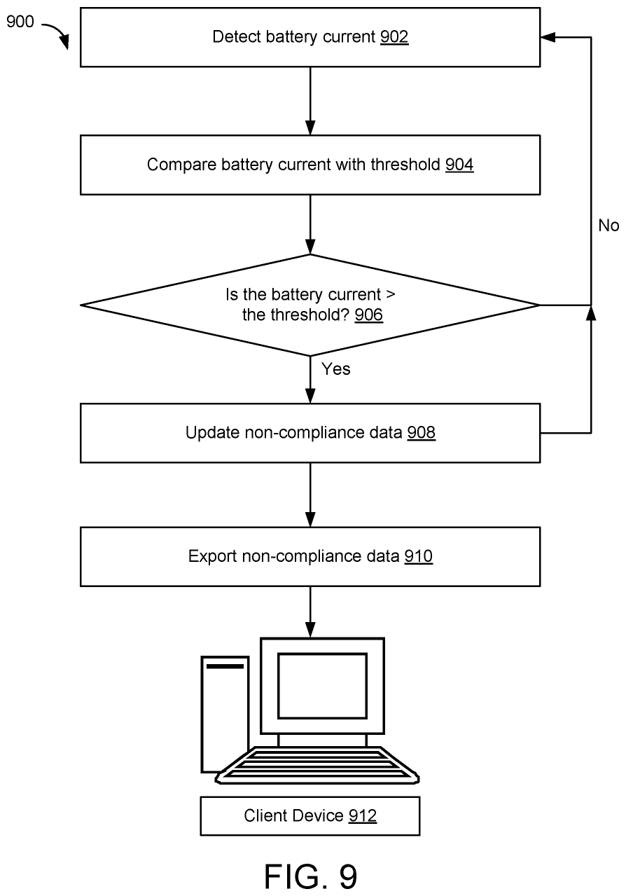

Referring now to FIG. 9, a method 900 for operating the battery controller and memory is shown, according to an exemplary embodiment. The battery controller 116 may implement the method 900, at least in part. The method 900 begins at step 902 with the battery controller receiving the battery current from a battery (e.g., battery 104), which is updated or calculated in real-time by the battery controller 116. The battery current may be determined from a real-time state of charge, a real-time temperature, and a real-time load or usage time of the battery 104. At step 904, the battery controller 116 will receive operating limits (e.g., operating limits 210) from memory (e.g., memory 208). The operating limits 210 define acceptable operating ranges or limits for current, voltage, and/or power of the battery 104 during operation, which may be determined, based a state of charge, a temperature, and a load or usage time of the battery 104. The operating limits contain predetermined thresholds (e.g., shutdown thresholds) to ensure the life of the battery 104 is not compromised form prolonged use beyond the shutdown threshold. At step 904, the battery controller 116 will compare the real-time battery current from step 902 with the shutdown threshold from the operating limits 210 and compare the values of each current to determine the optimal or excessive use of the battery 104.

At step 906, the battery controller 116 determines if the battery current is above the shutdown threshold. If the battery current is not above the shutdown threshold, the method 900 begins again starting at step 902. If the battery current is above the shutdown threshold, the method 900 will proceed to step 908. At step 908, the noncompliance event counter will increment by one to indicate that said user is not complying with the thresholds established by the battery controller 116. The method 900 will start again at step 902 to monitor for noncompliance. The method 900 will proceed to step 910 when there is an attempt to export the compliance data. At step 910, the compliance data will be exported to a client device 912, which includes an electronic computing device that executes hardware (e.g., processor, non-transitory storage medium) and software.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be understood that while the use of words such as desirable or suitable utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” or “at least one” are used there is no intention to limit the claim to only one item unless specifically stated to the contrary in the claim.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

As used herein, the term “circuit” or “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

The construction and arrangement of the suspension as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A lawn mower comprising:
a drive wheel;
a mowing deck including a cutting blade;
a wheel motor operable to rotate the drive wheel;
a cutting blade motor operable to rotate the cutting blade; and
a battery system comprising:
a battery configured to power the wheel motor and the cutting blade motor; and
a battery controller communicably coupled to the battery, the battery controller comprising one or more processors and memory storing instructions that, when executed by the one or more processors, cause the one or more processors to:
determine an electric current threshold for the battery;
broadcast a message comprising the electric current threshold;
compare an actual electric current of the battery to the electric current threshold; and
adjust an operation of the battery system in response in response to determining that the actual electric current of the battery exceeds the electric current threshold for a predetermined amount of time.

2. The lawn mower of claim 1, wherein:
the electric current threshold for the battery comprises both a shutdown current threshold and a recommended current threshold; and
the message broadcast by the battery controller comprises both the shutdown current threshold and the recommended current threshold.

3. The lawn mower of claim 1, wherein:
the battery controller comprises a plurality of power maps, each power map of the plurality of power maps comprising a different value of the electric current threshold; and
determining the electric current threshold comprises obtaining a value of the electric current threshold from an active power map of the plurality of power maps.

4. The lawn mower of claim 1, further comprising a vehicle controller communicably coupled to the battery controller and configured to operate the cutting blade motor and the wheel motor using the actual electric current from the battery;
wherein the message broadcast by the battery controller is provided to the vehicle controller and comprises at least one of a recommendation for the vehicle controller to reduce the actual electric current of the battery or a warning that the battery will be shut down if the actual electric current is not reduced;
wherein the vehicle controller is configured to selectively disable or de-rate at least one of the cutting blade motor or the wheel motor in response to receiving the message from the battery controller.

5. The lawn mower of claim 1, wherein:
the electric current threshold for the battery comprises a shutdown current threshold; and
adjusting the operation of the battery system comprises shutting down the battery in response to determining that the actual electric current of the battery exceeds the shutdown current threshold for the predetermined amount of time.

6. The lawn mower of claim 1, wherein:
the electric current threshold for the battery comprises a recommended current threshold; and
adjusting the operation of the battery system comprises transitioning from a first power map to a second power map in response to determining that the actual electric current of the battery exceeds the recommended current threshold for the predetermined amount of time.

7. The lawn mower of claim 6, wherein:
the first power map comprises a first value of the recommended current threshold;
the second power map comprises a second value of the recommended current threshold different from the first value of the recommended current threshold; and
transitioning from the first power map to the second power map comprises updating the recommended current threshold from the first value to the second value.

8. The lawn mower of claim 1, wherein:
the battery system comprises a sensor configured to measure a transitory condition of the battery, the transitory condition comprising at least one of a temperature of the battery, a state of charge of the battery, a voltage of the battery, or the actual electric current of the battery;
the battery controller is configured to dynamically update the electric current threshold for the battery based on a measured value of the transitory condition of the battery.

9. A battery system comprising:
a battery comprising one or more battery cells configured to charge and discharge using electric current;
a sensor configured to measure a transitory condition of the battery;
a battery controller communicably coupled to the battery and the sensor, the battery controller comprising one or more processors and memory storing instructions that, when executed by the one or more processors, cause the one or more processors to:
determine an electric current threshold for the battery based on the transitory condition of the battery;
broadcast a message comprising the electric current threshold;
compare an actual electric current of the battery to the electric current threshold; and
adjust an operation of the battery system in response in response to determining that the actual electric current of the battery exceeds the electric current threshold for a predetermined amount of time.

10. The battery system of claim 9, wherein:
the electric current threshold for the battery comprises both a shutdown current threshold and a recommended current threshold; and
the message broadcast by the battery controller comprises both the shutdown current threshold and the recommended current threshold.

11. The battery system of claim 9, wherein the message broadcast by the battery controller is provided to an application controller and comprises at least one of a recommendation for the application controller to reduce the actual electric current of the battery or a warning that the battery will be shut down if the actual electric current is not reduced.

12. The battery system of claim 9, wherein:
the battery controller comprises a plurality of power maps, each power map of the plurality of power maps comprising a different value of the electric current threshold; and
determining the electric current threshold comprises obtaining a value of the electric current threshold from an active power map of the plurality of power maps.

13. The battery system of claim 9, wherein:
the electric current threshold for the battery comprises a shutdown current threshold; and
adjusting the operation of the battery system comprises shutting down the battery in response to determining that the actual electric current of the battery exceeds the shutdown current threshold for the predetermined amount of time.

14. The battery system of claim 9, wherein:
the electric current threshold for the battery comprises a recommended current threshold; and
adjusting the operation of the battery system comprises transitioning from a first power map to a second power map in response to determining that the actual electric current of the battery exceeds the recommended current threshold for the predetermined amount of time.

15. The battery system of claim 14, wherein:
the first power map comprises a first value of the recommended current threshold;
the second power map comprises a second value of the recommended current threshold different from the first value of the recommended current threshold; and
transitioning from the first power map to the second power map comprises updating the recommended current threshold from the first value to the second value.

16. The battery system of claim 9, wherein:
the transitory condition of the battery comprises at least one of a temperature of the battery, a state of charge of the battery, a voltage of the battery, or the actual electric current of the battery;
the battery controller is configured to dynamically update the electric current threshold for the battery based on a measured value of the transitory condition of the battery.

17. A method for operating a battery comprising one or more battery cells configured to charge and discharge using electric current, the method comprising:
measuring a transitory condition of the battery;
determining an electric current threshold for the battery based on the transitory condition of the battery;
broadcasting a message comprising the electric current threshold;
comparing an actual electric current of the battery to the electric current threshold; and
adjusting an operation of the battery system in response in response to determining that the actual electric current of the battery exceeds the electric current threshold for a predetermined amount of time.

18. The method of claim 17, wherein the electric current threshold for the battery comprises both a shutdown current threshold and a recommended current threshold; and
the message broadcast by the battery controller comprises both the shutdown current threshold and the recommended current threshold.

19. The method of claim 17, wherein:
the electric current threshold for the battery comprises a shutdown current threshold; and
adjusting the operation of the battery system comprises shutting down the battery in response to determining that the actual electric current of the battery exceeds the shutdown current threshold for the predetermined amount of time.

20. The method of claim 17, wherein:
the electric current threshold for the battery comprises a recommended current threshold; and
adjusting the operation of the battery system comprises transitioning from a first power map to a second power map in response to determining that the actual electric current of the battery exceeds the recommended current threshold for the predetermined amount of time.
